(19) United States
(12) Patent Application Publication
(10) Pub. No.: US 2008/0240324 A1
(43) Pub. Date: Oct. 2, 2008

(54) Independent Dispatch of Multiple Streaming Queues Via Reserved Time Slots

(75) Inventors: Egidio Sburlino, Seattle, WA (US); Ellick H. Sung, Seattle, WA (US)

Correspondence Address: MICROSOFT CORPORATION, ONE MICROSOFT WAY, REDMOND, WA, 98052-6399, US

(73) Assignee: Microsoft Corporation, Redmond, WA (US)

(21) Appl. No.: 11/691,878

(22) Filed: Mar. 27, 2007

(51) Int. Cl. H04L 25/38

(52) U.S. Cl. 375/370; 375/E07.02

(57) ABSTRACT

Technologies for scheduling the dispatch of multi-channel isochronous constant-rate data, such as real-time and/or streaming audio data, video data, or the like. The technologies include systems and methods that provide for the independent dispatch of such data from each of multiple channels such that data delays in one channel have no adverse affect on the dispatch of data from another channel.

### BACKGROUND

The transport of multiple channels of isochronous constant-rate data is increasingly popular given the advent of personal computing devices used for communications. Wireless devices for transporting such data are also increasingly popular. Isochronous constant-rate data, such as real-time and/or streaming audio and/or video data, tend to require low transport latencies while also being tolerant of some loss. Various technologies for transporting multiple channels of such data are becoming more common. For example, three persons may concurrently listen to music streamed from a personal computer (“PC”) to wireless headsets, the wireless link between each headset and the PC comprising an isochronous, constant-rate data channel. One example technology for transporting such data is Bluetooth.

The scheduling of multiple isochronous constant-rate data streams can be a difficult problem. Due to the time-dependent nature of such data, data from multiple streams or channels must be interlaced and delivered to an underlying transport mechanism at regular intervals or time slots. Problems can occur if data from one of the channels is delayed or missing at the time of scheduling. In such a case, a decision must be made as to whether or not to wait for data that is not available at the time of scheduling but that may be ready in time for actual transport. If a scheduler waits too long for the delayed data, it risks delaying other channels which may have data ready to be sent. If it skips the delayed data and continues on to the next data channel, the scheduler may skip data that would otherwise have been ready by the time the channel was scheduled (the arrival of the associated time slot) for actual transport. Such difficulties can lead to unacceptable multi-channel operation.

### SUMMARY

The following presents a simplified summary of the disclosure in order to provide a basic understanding to the reader. This summary is not an extensive overview of the disclosure and it does not identify key/critical elements of the invention or delineate the scope of the invention. Its sole purpose is to present some concepts disclosed herein in a simplified form as a prelude to the more detailed description that is presented later.

The present examples provide technologies for scheduling the dispatch of multi-channel isochronous constant-rate data, such as real-time and/or streaming audio data, video data, or the like. The technologies include systems and methods that provide for the independent dispatch of such data from each of multiple channels such that data delays in one channel have no adverse affect on the dispatch of data from another channel.

Many of the attendant features will be more readily appreciated as the same become better understood by reference to the following detailed description considered in connection with the accompanying drawings.

### DESCRIPTION OF THE DRAWINGS

The present description will be better understood from the following detailed description considered in connection with the accompanying drawings, wherein:

FIG. 1 is block diagram showing an example system sufficient to practice the present invention.

FIG. 2 is a block diagram showing an example scheduler including components sufficient to perform methods of the present invention.

FIG. 3 is a block diagram showing an example method for dispatching isochronous constant-rate data in a multi-channel system.

FIG. 4 is a block diagram showing an example computing environment in which the technologies described herein may be implemented.

Like reference numerals are used to designate like parts in the accompanying drawings.

### DETAILED DESCRIPTION

The detailed description provided below in connection with the accompanying drawings is intended as a description of the present examples and is not intended to represent the only forms in which the present examples may be constructed or utilized. The description sets forth at least some of the functions of the examples and/or the sequence of steps for constructing and operating examples. However, the same or equivalent functions and sequences may be accomplished by different examples.

Although the present examples are described and illustrated herein as being implemented in a computing environment, the environment described is provided as an example and not a limitation. As those skilled in the art will appreciate, the present examples are suitable for application in a variety of different types of computing environments or the like.

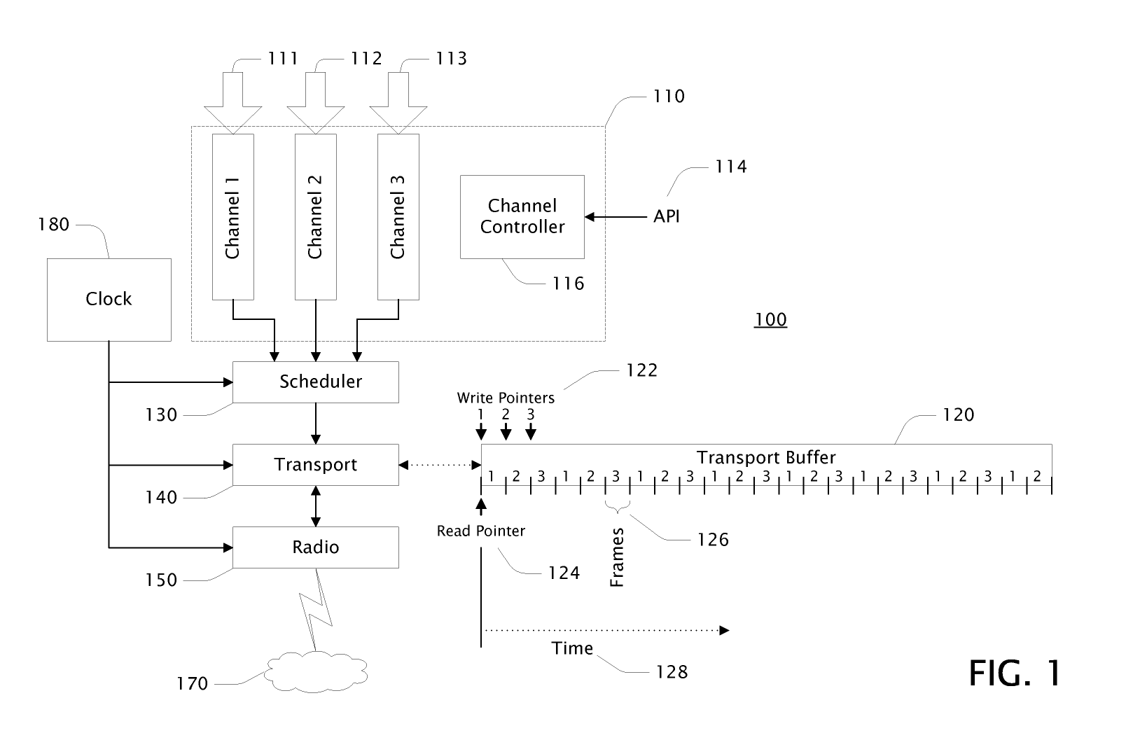

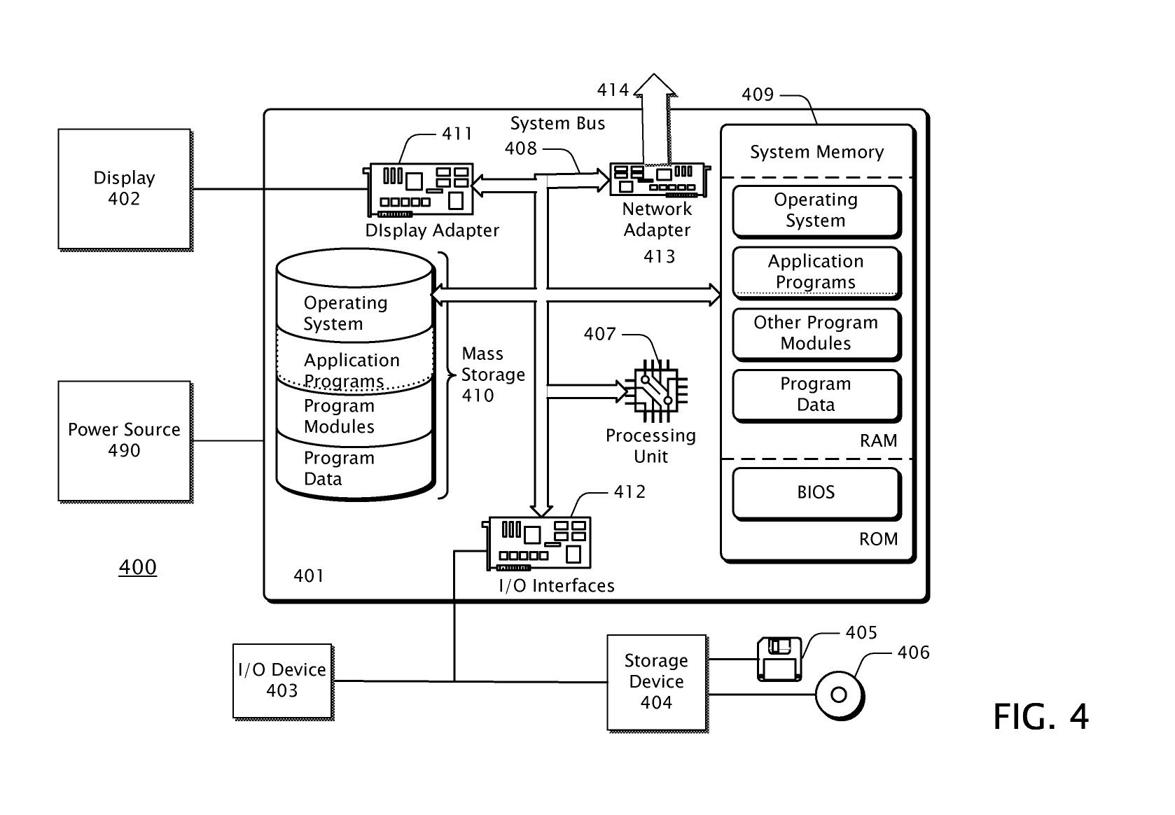

FIG. 1 is block diagram showing an example system 100 sufficient to practice the present invention. System 100 typically operates in a computing environment, such as described in connection with FIG. 4. System 100 generally allows for one or more synchronous connection-oriented channels or the like (“channel”) to be established suitable for transporting constant-rate, isochronous data, such as streaming and/or real-time audio or video data or the like. In one example, such a channel corresponds to a Bluetooth synchronous connection oriented (“SCO”) link or extended SCO (“eSCO”) link, with both SCO and eSCO being referred to herein as “SCO”.

Block 110 includes example channel controller 116 and three example channels, channels 1, 2 and 3. Users of system 100, such as software applications, programs, systems, or the like (“users” or “user applications”), typically interact with system 100 via protocol or application interface (“API”) 114. Users are typically able to allocate or establish one or more channels via channel controller 116 using API 114.

Users of system 100 typically transport channel data over allocated channels using channel interfaces, such as example interfaces 111-113. Such channel interfaces may be part of API 114. System 100 generally supports multiple users, each user allocating one or more channels. In one example, system 100 may establish between one and three SCO channels.

Example channels 1-3 typically provide a constant-rate transport with data transmission intervals locked to timing signals provide by example clock 180. Data is generally transported via a channel in fixed size packets at fixed intervals, typically as specified when the channel is established. Clock 180 provides signals that establish a fixed interval or constant rate of transmission. For example, at each constant-rate interval indicated by clock 180, data in transport buffer 120 at the location of read pointer 124 is read and transmitted and read pointer 124 is advanced to the next frame of transport buffer 120. Thus, read pointer 124 is locked to clock 180, advancing through the frames of transport buffer 120, sequentially indicating the frames of data to be read from the buffer, the data being transmitted in lock-step with constant-rate timing signals from clock 180.

For data being sent from system 100, example scheduler 130 typically provides data from the established channels to transport 140. This typically occurs by breaking data into fixed-size packets that correspond to frames, such as example frame 126, in transport buffer 120 and dispatching the packets or writing them into the buffer.

Transport buffer 120 is typically partitioned to provide a series of frames in a repeating sequential fashion for each established channel, with a corresponding write pointer for each channel, such as example write pointers 122. For example, each fixed-size packet from channel 1 is typically dispatched or written to transport buffer 120 at the location of the write pointer for channel 1. If only a single channel is allocated, then transport buffer 120 is dedicated entirely to data packets from channel 1. Alternatively, if two channels are allocated, then buffer frames alternate for data packets from channel 1 and channel 2, the corresponding write pointers pointing to the next available frame location in buffer 120 for each channel. A similar example with three channels is shown in FIG. 1.

Transport 140 typically reads any data in transport buffer 120, the reading generally taking place in lock-step with constant-rate timing signals from clock 180. The location of reads is controlled by read pointer 124 which generally moves forward in the buffer, as indicated by timing indicator 128, according to clock 180 timing signals. Generally, once read pointer 124 advances past a frame, that frame is no longer available for writing by scheduler 130.

Transport 140 provides data packets that have been read from transport buffer 120 to example radio 150 for transmission. Radio 150 subsequently transmits the frames to their destination. Destinations, such as indicated by cloud 170, are typically other computing environments including an instance of system 100.

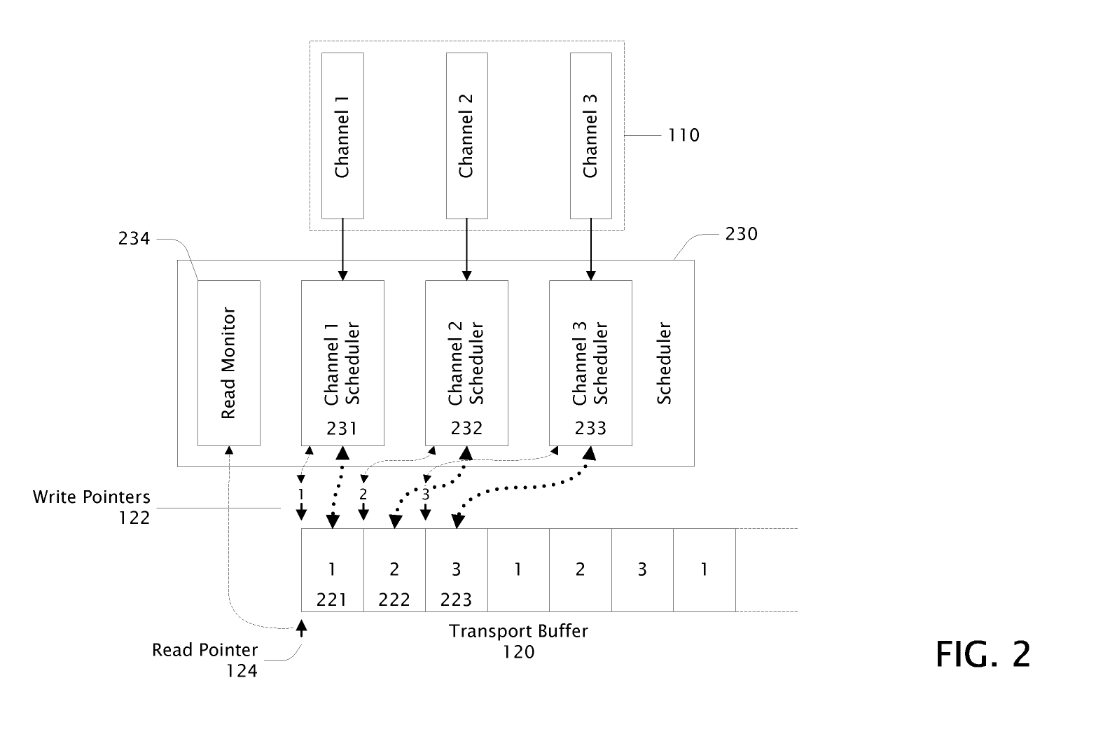

FIG. 2 is a block diagram showing an example scheduler 230 including components 231-234 sufficient to perform methods of the present invention. Scheduler 230 is shown coupled to channels 1, 2, and 3, and is shown in relation to transport buffer 120. An element shown in FIG. 2 with the same numerical designation as an element shown in FIG. 1 generally represent the same element and are described in connection with FIG. 1. The multiplexing is performed so as to decouple the dispatch of data packets of one user from those of another user. This decoupling resolves scheduling problems caused by delayed packet delivery from users providing data for isochronous, constant-rate transport.

Example channel schedulers 231-233 are typically established in conjunction with the allocation of a corresponding channel. For example, when a user application allocates a single channel, say channel 1, a corresponding channel scheduler is also established, channel 1 scheduler 231. Alternatively, if two channels are allocated via one or more users then two channel schedulers are established (such as channel 1-2 schedulers 231 and 232). If three channels are allocated then three channel schedulers are established (such as channel 1-3 schedulers 231-233), and so forth.

Each channel scheduler typically schedules the writing of data packets from a corresponding channel into appropriate frames or time slots in transport buffer 120. Each channel scheduler writes the next available data packet into the frame in the buffer indicated by a corresponding write pointer. Data packets are typically made available after a user writes them to a channel, such as channels 1, 2, and 3. For example, channel 1 scheduler 231 writes the next available data packet from channel 1 into frame 221 pointed to by write pointer 1 (as indicated by the dotted arrow between 231 and 221), after which the pointer is advance to the next frame of transport buffer 120 reserved for data packets from channel 1. Note the number from 1 to 3 printed in each frame of example transport buffer 120 in FIG. 1 and FIG. 2, the number indicating the channel for which the frame is reserved. Frames are generally reserved in a repeating sequential fashion, such as for example 1-2-3, 1-2-3, 1-2-3, and so on given three allocated channels, as shown for transport buffer 120 in FIG. 1 and FIG. 2.

The dashed arrow drawn between channel 3 scheduler 233 and frame 223 indicates control over the channel 3 write arrow by channel 3 scheduler 233. A similar dashed arrow is shown between channel 1 scheduler 231 and frame 221, and between channel 2 scheduler 232 and frame 222. In practice, control of write pointers may be maintained via elements of scheduler 230 and/or in conjunction with transport 140.

Read monitor 234 is typically an element or function of scheduler 230 that monitors the position of read pointer 124, as indicated by the dashed arrow between read pointer 124 and read monitor 234. Read pointer 124 is typically advanced one frame by transport 140 as each data packet is read from transport buffer 120 and transmitted over the physical media, such as radio 150. Read monitor 234 generally compares the position of each of the write pointers 122 to the position of read pointer 124. If a data packet to be written at a write pointer buffer location doesn't become available until after the read pointer advances past the write pointer, then scheduler 230 generally discards the late data packet. For example, if read pointer 124 advances to frame 222 before a data packet becomes available for channel 1 scheduler 231 to write into frame 221, then channel 1 scheduler 231 discards the late data packet and advances the channel 1 write pointer to the next channel 1 frame location in transport buffer 120, or the frame following frame 223. Alternatively, channel 1 scheduler 231 may write the data packet into frame 221 even though read pointer 224 has already advanced past the channel 1 write pointer as the data packet is thus written too late to be read. Generally, each channel scheduler operates similarly to yet independently from any others. By establishing such independent channel schedulers for each allocated channel, isochronous constant-rate data from each channel may be independently dispatched such that data availability delays from one channel do not adversely impact data being sent from other channels.

In one example, channels 110 correspond to Bluetooth SCO streams and transport buffer 120 corresponds to a universal serial bus (“USB”) frame buffer associated with a Bluetooth USB interface. In this example, the data packets of a particular SCO stream always arrive in order, but data packets between SCO streams may arrive out of order. For example, channel 1 may make available two packets, then channel 3 one packet, followed by channel 2 three packets, etc. Scheduler 230 dispatches data packets from multiple SCO streams, even when the packets arrive out of order between streams, to the USB interface such that they are transmitted via the USB bus in proper order. Any packet arrive too late to be dispatched and transmitted in proper order is typically dropped.

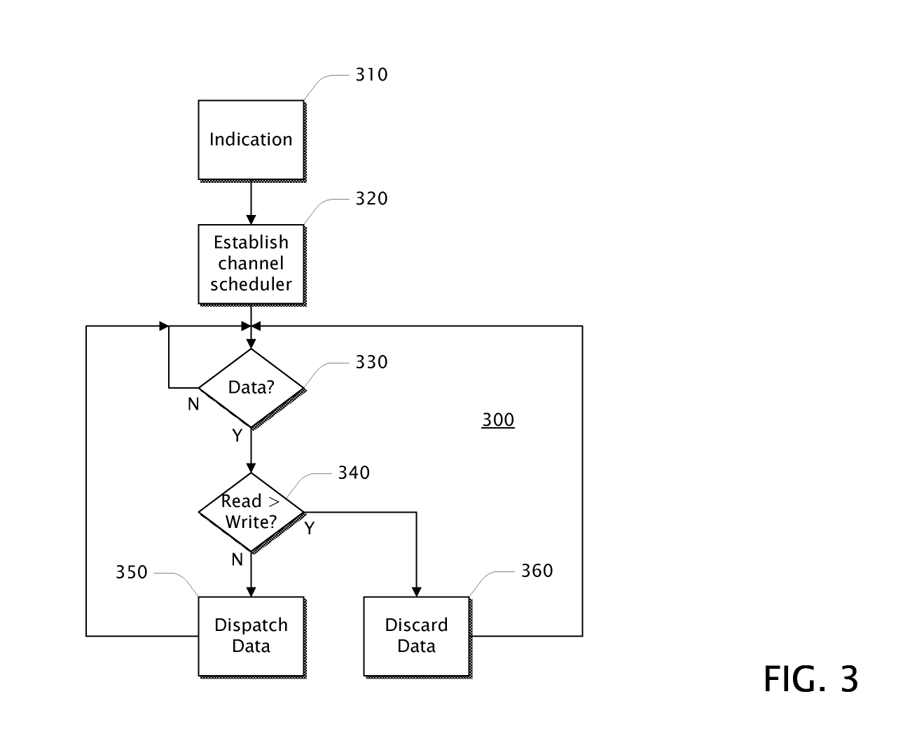

FIG. 3 is a block diagram showing an example method 300 for dispatching isochronous constant-rate data in a multi-channel system. The method 300 includes establishing a channel scheduler for each channel that is allocated, each channel scheduler operating independent of the others. Further, a sequence of frames is defined in a transport buffer with one frame for each channel, and the sequence repeating. In summary, as data becomes available in a channel, the associated channel scheduler determines if there is time available prior to constant-rate transmission to write the data into the transport buffer for transmission, If so, the data is written to a frame indicated by a write pointer associated with the channel, and the write pointer is advanced to the frame associated with the channel in the next sequence of frames. If not, then the data is discarded. At the same time, a constant-rate transmission clock is driving read and transmit operations at a regular interval, reading and transmitting at each interval the frame of data pointed to by the read pointer of the transport buffer, the read pointer being incremented to the next frame after each read. Method 300 is described in additional detail below.

Block 310 indicates receiving an indication that a new channel has been allocated. The channel allocation process, which is separate from method 300, typically includes the following: For each newly allocated channel, the transport buffer is further subdivided such that each sequence of frames includes a frame for the new channel. A write pointer is also established for the new channel that points to the next available frame for the channel. Frames are typically sized to represent a specific duration of time. In one example, the frames in a system with three channels accept 9 millisecond (“ms”) chunks of data. In another example, the frames in a system with two channels accept 6 millisecond (“ms”) chunks of data. Once an indication is received, method 300 typically continues at block 320.

Block 320 indicates establishing a channel scheduler for the newly allocated channel. The channel scheduler monitors the new channel for data available to be transported. Each such channel scheduler operates independently of other channel schedulers. That is, no channel scheduler is blocked from dispatching data from its channel due to delays in data arrival or the like on other channels. Once a channel scheduler is established, method 300 typically continues at block 330.

Block 330 indicates the channel scheduler determining if data is available in the channel for dispatch. When a user of the system, typically the user that allocated the new channel, writes data to the channel, then data is available for dispatch. If data is available, method 300 typically continues at block 340.

Block 340 indicates determining if the read pointer has advanced beyond the new channel's write pointer. This typically occurs if there is a delay in channel data availability beyond the time that the frame is to be transmitted. If the read pointer had advanced beyond the new channel's write pointer, then method 300 typically continues at block 360. Otherwise method 300 typically continues at block 350.

Block 350 indicates dispatching data from the new channel. Generally the channel scheduler will read a packet of data from the new channel and write the data packet into the frame of the transport buffer pointed to by the write pointer for the new channel. Data packets are generally read from the channel in first-in, first-out (“FIFO”) order. After a data packet has been dispatched, method 300 typically continues at block 330.

Block 360 indicates discarding data from the new channel. Generally the channel scheduler will discard a packet of data from the new channel, the data packet discarded being the one that would have been dispatched (see block 350) had it not been delayed beyond the channel's frame transmission time. In an alternative example, the data packet is dispatched as indicated by block 350, but the packet is never transmitted because the transport read pointer is already beyond the frame of the late data packet. After the data packet is discarded, method 300 typically continues at block 330.

FIG. 4 is a block diagram showing an example computing environment 400 in which the technologies described herein may be implemented. A suitable computing environment may be implemented with numerous general purpose or special purpose systems. Examples of well known systems may include, but are not limited to, cell phones, personal digital assistants (“PDA”), personal computers (“PC”), hand-held or laptop devices, microprocessor-based systems, multiprocessor systems, servers, workstations, consumer electronic devices, set-top boxes, and the like.

Computing environment 400 typically includes a general-purpose computing system in the form of a computing device 401 coupled to various components, such as peripheral devices 402, 403, 404 and the like. System 400 may couple to various other components, such as input devices 403, including voice recognition, touch pads, buttons, keyboards and/or pointing devices, such as a mouse or trackball, via one or more input/output (“I/O”) interfaces 412. The components of computing device 401 may include one or more processors (including central processing units (“CPU”), graphics processing units (“GPU”), microprocessors (“pP”), and the like) 407, system memory 409, and a system bus 408 that typically couples the various components. Processor 407 typically processes or executes various computer-executable instructions to control the operation of computing device 401 and to communicate with other electronic and/or computing devices, systems or environment (not shown) via various communications connections such as a network connection 414 or the like. System bus 408 represents any number of several types of bus structures, including a memory bus or memory controller, a peripheral bus, a serial bus, an accelerated graphics port, a processor or local bus using any of a variety of bus architectures, and the like.

System memory 409 may include computer readable media in the form of volatile memory, such as random access memory (“RAM”), and/or non-volatile memory, such as read only memory (“ROM”) or flash memory (“FLASH”). A basic input/output system (“BIOS”) may be stored in non-volatile or the like. System memory 409 typically stores data, computer-executable instructions and/or program modules comprising computer-executable instructions that are immediately accessible to and/or presently operated on by one or more of the processors 407.

Mass storage devices 404 and 410 may be coupled to computing device 401 or incorporated into computing device 401 via coupling to the system bus. Such mass storage devices 404 and 410 may include non-volatile RAM, a magnetic disk drive which reads from and/or writes to a removable, non-volatile magnetic disk (e.g., a “floppy disk”) 405, and/or an optical disk drive that reads from and/or writes to a non-volatile optical disk such as a CD ROM, DVD ROM 406. Alternatively, a mass storage device, such as hard disk 410, may include non-removable storage medium. Other mass storage devices may include memory cards, memory sticks, tape storage devices, and the like.

Any number of computer programs, files, data structures, and the like may be stored in mass storage 410, other storage devices 404, 405, 406 and system memory 409 (typically limited by available space) including, by way of example and not limitation, operating systems, application programs, data files, directory structures, computer-executable instructions, and the like.

Output components or devices, such as display device 402, may be coupled to computing device 401, typically via an interface such as a display adapter 411. Output device 402 may be a liquid crystal display (“LCD”). Other example output devices may include printers, audio outputs, voice outputs, cathode ray tube (“CRT”) displays, tactile devices or other sensory output mechanisms, or the like. Output devices may enable computing device 401 to interact with human operators or other machines, systems, computing environments, or the like. A user may interface with computing environment 400 via any number of different I/O devices 403 such as a touch pad, buttons, keyboard, mouse, joystick, game pad, data port, and the like. These and other I/O devices may be coupled to processor 407 via I/O interfaces 412 which may be coupled to system bus 408, and/or may be coupled by other interfaces and bus structures, such as a parallel port, game port, universal serial bus (“USB”), fire wire, infrared (“IR”) port, and the like.

Computing device 401 may operate in a networked environment via communications connections to one or more remote computing devices through one or more cellular networks, wireless networks, local area networks (“LAN”), wide area networks (“WAN”), storage area networks (“SAN”), the Internet, radio links, optical links and the like. Computing device 401 may be coupled to a network via network adapter 413 or the like, or, alternatively, via a modem, digital subscriber line (“DSL”) link, integrated services digital network (“ISDN”) link, Internet link, wireless link, or the like.

Communications connection 414, such as a network connection, typically provides a coupling to communications media, such as a network. Communications media typically provide computer-readable and computer-executable instructions, data structures, files, program modules and other data using a modulated data signal, such as a carrier wave or other transport mechanism. The term “modulated data signal” typically means a signal that has one or more of its characteristics set or changed in such a manner as to encode information in the signal. By way of example, and not limitation, communications media may include wired media, such as a wired network or direct-wired connection or the like, and wireless media, such as acoustic, radio frequency, infrared, or other wireless communications mechanisms.

Power source 490, such as a battery or a power supply, typically provides power for portions or all of computing environment 400. In the case of the computing environment 400 being a mobile device or portable device or the like, power source 490 may be a battery. Alternatively, in the case computing environment 400 is a desktop computer or server or the like, power source 490 may be a power supply designed to connect to an alternating current (“AC”) source, such as via a wall outlet.

Some mobile devices may not include many of the components described in connection with FIG. 4. For example, an electronic badge may be comprised of a coil of wire along with a simple processing unit 407 or the like, the coil configured to act as power source 490 when in proximity to a card reader device or the like. Such a coil may also be configure to act as an antenna coupled to the processing unit 407 or the like, the coil antenna capable of providing a form of communication between the electronic badge and the card reader device. Such communication may not involve networking, but may alternatively be general or special purpose communications via telemetry, point-to-point, RF, IR, audio, or other means. An electronic card may not include display 402, I/O device 403, or many of the other components described in connection with FIG. 4. Other mobile devices that may not include many of the components described in connection with FIG. 4, by way of example and not limitation, include electronic bracelets, electronic tags, implantable devices, and the like.

Those skilled in the art will realize that storage devices utilized to provide computer-readable and computer-executable instructions and data can be distributed over a network. For example, a remote computer or storage device may store computer-readable and computer-executable instructions in the form of software applications and data. A local computer may access the remote computer or storage device via the network and download part or all of a software application or data and may execute any computer-executable instructions. Alternatively, the local computer may download pieces of the software or data as needed, or distributively process the software by executing some of the instructions at the local computer and some at remote computers and/or devices.

Those skilled in the art will also realize that, by utilizing conventional techniques, all or portions of the software's computer-executable instructions may be carried out by a dedicated electronic circuit such as a digital signal processor (“DSP”), programmable logic array (“PLA”), discrete circuits, and the like. The term “electronic apparatus” may include computing devices or consumer electronic devices comprising any software, firmware or the like, or electronic devices or circuits comprising no software, firmware or the like.

The term “firmware” typically refers to executable instructions, code, data, applications, programs, or the like maintained in an electronic device such as a ROM. The term “software” generally refers to executable instructions, code, data, applications, programs, or the like maintained in or on any form of computer-readable media. The term “computer-readable media” typically refers to system memory, storage devices and their associated media, and the like.

In view of the many possible embodiments to which the principles of the present invention and the forgoing examples may be applied, it should be recognized that the examples described herein are meant to be illustrative only and should not be taken as limiting the scope of the present invention. Therefore, the invention as described herein contemplates all such embodiments as may come within the scope of the following claims and any equivalents thereto.

1. A multi-channel isochronous data transport scheduling system including a constant-rate data transmission clock, the system comprising:
a channel scheduler associated with an isochronous data channel, and with a transport buffer including a read pointer, and with a write pointer associated with frames of the transport buffer that are allocated to the isochronous data channel, the channel scheduler operating independent of other channel schedulers; and
a read monitor associated with the read pointer, the read monitor operable to determine if the read pointer has advanced past the write pointer prior to data becoming available via the isochronous data channel.

2. The system of claim 1, wherein the channel scheduler writes the data into a frame of the frames, the frame pointed to by the write pointer.

3. The system of claim 2, wherein the channel scheduler writes the data if the read pointer has not advanced past the write pointer as determined by the read monitor

4. The system of claim 1, wherein the read pointer is a constant-rate read pointer advancing through the transport buffer in lock-step with timing signals from the constant-rate data transmission clock.

5. The system of claim 1, wherein the isochronous data channel is a Bluetooth synchronous connection oriented link or extended synchronous connection oriented link.

6. The system of claim 1, where in the data is divided into packets.

7. The system of claim 1, wherein the data includes streaming audio data or streaming video data.

8. The system of claim 1, wherein the data includes real-time audio data or real-time video data.

9. The system of claim 1, further comprising a wireless means for transmitting the data.

10. The system of claim 1, further comprising a second channel scheduler associated with a second isochronous data channel, and with the transport buffer, and with a second write pointer associated with frames of the transport buffer allocated for the second isochronous data channel, the second channel scheduler operating independent of the channel scheduler.

11. The system of claim 10, further comprising a third channel scheduler associated with a third isochronous data channel, and with the transport buffer, and with a third write pointer associated with frames of the transport buffer allocated for the third isochronous data channel, the third channel scheduler operating independent of the channel scheduler and the second channel scheduler.

12. The system of claim 1, wherein the frames of the transport buffer are allocated to isochronous data channels in a repeating sequential fashion.

13. A method of dispatching multi-channel isochronous data in a constant-rate fashion, the method comprising:
receiving an indication upon allocation of an isochronous data channel;
establishing a channel scheduler associated with the isochronous data channel, and with a transport buffer including a read pointer, and with a write pointer associated with frames of the transport buffer that are allocated to the isochronous data channel, the channel scheduler operating independent of other channel schedulers;
the channel scheduler dispatching a data packet from the isochronous data channel to a frame of the frames, the frame pointed to by the write pointer.

14. The method of claim 13, wherein the channel scheduler dispatches the data packet if the read pointer has not advanced beyond the write pointer.

15. The method of claim 13, wherein the read pointer is a constant-rate read pointer advancing through the transport buffer in lock-step with timing signals from a constant-rate data transmission clock.

16. The method of claim 13, wherein the isochronous data channel is a Bluetooth synchronous connection oriented link or extended synchronous connection oriented link.

17. The method of claim 13, wherein the data packet includes streaming audio data or streaming video data.

18. The method of claim 13, wherein the data packet includes real-time audio data or real-time video data.

19. The method of claim 13, wherein the frames of the transport buffer are allocated to isochronous data channels in a repeating sequential fashion.

20. A computer-readable medium comprising computer-executable instructions for performing a method of dispatching multi-channel isochronous data in a constant-rate fashion, the method comprising:
receiving an indication upon allocation of an isochronous data channel;
establishing a channel scheduler associated with the isochronous data channel, and with a transport buffer including a read pointer, and with a write pointer associated with frames of the transport buffer that are allocated to the isochronous data channel, the channel scheduler operating independent of other channel schedulers, wherein the read pointer is a constant-rate read pointer advancing through the transport buffer in lock-step with timing signals from a constant-rate data transmission clock;
the channel scheduler dispatching a data packet from the isochronous data channel to a frame of the frames, the frame pointed to by the write pointer, if the read pointer has not advanced beyond the write pointer.
